(19) United States
(12) Patent Application Publication
(10) Pub. No.: US 2006/0245366 A1
(43) Pub. Date: Nov. 2, 2006

(54) Method and device for optimized adsl data transmission

(76) Inventor: Stephan Binde, Baierbrunn (DE)

Correspondence Address: Siemens Corporation;Intellectual Property Department, 170 Wood Avenue South, Iselin, NJ, 08830, US

(21) Appl. No.: 10/494,736

(22) PCT Filed: Nov. 4, 2002
(86) PCT No.: PCT/DE02/04084

§ 371 Date: Feb. 2, 2005

(30) Foreign Application Priority Data
Nov. 7, 2001 (DE) 101 54 644.0

(51) Int. Cl. H04J 1/16

(52) U.S. Cl. 370/246

(57) ABSTRACT

The invention relates to a method and a device for optimized ADSL data transmission, preferably according to the standard T1.413 or ITU G992.1, whereby on a line fault occurring, a training procedure is initiated to determine the highest possible data transmission rate and during an uninterrupted data transfer period following a training phase (T), a highest possible data transmission rate is set without carrying out a new training, by successive increases in the applied bit rate in at least one transmission band and monitoring of error counts.

### CROSS REFERENCE TO RELATED APPLICATIONS

This application is the US National Stage of International Application No. PCT/DE02/04084, filed Nov. 4, 2002 and claims the benefit thereof. The International Application claims the benefits of German application No. 10154644.0 filed Nov. 7, 2001, both applications are incorporated by reference herein in their entirety.

### FIELD OF INVENTION

The invention relates to a method and a device for optimized ADSL data transmission, preferably according to the standard T1.413 or ITU G992.1, whereby on a line fault occurring, a training procedure is initiated to determine the highest possible data transmission rate.

### BACKGROUND OF INVENTION

In general, the ADSL method (ADSL=asymmetrical digital subscriber line) is generally well-known in telecommunications. The ADSL method is a high-speed data transmission method using mostly already existing POTS telephone cabling. It is an asymmetrical broadband data transmission method which is connected to the conventional copper wire pair in the connecting range. For ADSL communication, an ADSL modem must be installed on both sides of the connecting line, namely both at the local switching center and on the subscriber side. In this way, the transmission is divided into three channels regarding its applied frequencies, namely the so-called channel downstream from the service provider to the end customer, the channel upstream from the end customer to the service provider and a channel via which a so-called splitter can connect in series the PSTN and ISDN communication at the same time. The signal of the upstream or downstream channel to be transmitted is also subdivided into many subsignals (frequency bins) that are transmitted via different carrier frequencies.

Standard specifications used at present for this type of data transmission for example are the standards T1.413 or ITU G992.1. In the case of these standardized ADSL data transmission methods the maximum data transmission rate is oriented individually to the quality of the specific transmission line that is referred to the specific line connection. For this, a training procedure is carried out, in which case, by measuring the line in the time and frequency range, the maximum possible rate of the data transmission is tested to be able to make available a data line efficiency that is as high as possible.

According to the above-mentioned standards, because the operated lines are continuously exposed to changes and faults that influence the maximum possible data transmission rate, a new training is initiated on the occurrence of a fault in order to determine the maximum permissible data transmission rate adapted to the currently changed situation in each case and subsequently to operate the corresponding data line with this new optimized data transmission rate. To be noted is the fact that only the occurrence of a fault event leads to a new evaluation of the data line. If there is no fault, the last determined value of the maximum possible data transmission rate remains.

Taking the above-mentioned standard methods into consideration results in the problem that in the case of an occurring fault that covers the training period and then again falls away, a data transmission rate which is essentially too low is generated, although on the basis of the falling away of the fault a higher data transmission rate would technically be possible.

A method of resolving this problem is well-known from U.S. Pat. No. 5,999,540. Here, in addition to the once-off training, an attempt is made to optimize the training results following this training by laying down typical data transmission rates with typical signal-to-noise ratios in a table and the current training results are compared with this empirically gained data. If the training results deviate too much from the empirically determined situations, a new training will be initiated. However in the final analysis, only the duration of the training is slightly lengthened in which case for a data transmission rate set once-off, a currently improved situation of the data transmission quality is subsequently not adapted. This means that even in the case of this method based on an unfavorable training period, a non-optimized data transmission rate with faults for this period and a subsequent termination of the fault for longer periods is retained.

### SUMMARY OF INVENTION

Therefore, the object of the invention is to find a method and a device for optimized ADSL data transmission that, on the one hand, prevents line faults that, as it happens, only occur in the training period in the long-term only bringing about a too low current data transmission rate compared with the technically possible data transmission rate and, on the other hand, prevent the transmission of useful data being interrupted by repeated training.

This object of the invention is achieved by the features of the independent patent claims. Advantageous further developments of the invention are part of the subordinate claims.

At present, the inventor has acknowledged that customary optimized ASDL data transmission methods, which based on an initial training phase, actually try to adapt their current possible data transmission rate to the technically possible data transmission rate has resulted in situations occurring in which, because of a fault for which the duration actually corresponds to the training duration there subsequently are now essentially too low actual data transmission rates. Because no further fault impulses follow, new training is also not initiated so that the actual data transmission rate remains far below the technically possible data transmission rate for a lengthy period. This unfavorable situation can be prevented by the fact that during the data transmission following training previously carried out, an attempt was made to successively increase the data transmission rate easily in which case nevertheless, at the same time, changing the error counts in this ADSL method is monitored so that it is possible to identify when the data transmission rate is in a range where there are too many data transmission errors so that here the data transmission rate can easily again be decreased. Therefore, as a result a continuous attempt is made to increase the data transmission rate and movement within the range of the highest possible data transmission rate results in fluctuations of this technically possible data transmission rate with a limited range of fluctuations. Nevertheless, as an indicator for exceeding the highest possible data transmission rate, the error indicators of this ADSL method such as for example the HEC error (HEC=header error check), the CRC error (CRC=cyclic redundancy checksum) or the SES count (SES=severely errored seconds) of the ADSL method according to T1.413 or ITU G992.1 is used.

According to the basic idea of this invention, the inventor proposes to greatly improve the method for optimized ADSL data transmission, preferably according to the Standard T1.413 or ITU G992.1, whereby on a line fault occurring, a training procedure is initiated to determine the highest possible data transmission rate, so that even during an uninterrupted data transfer period following a training phase, a highest possible data transmission rate is set without carrying out a new training, by successive increases in the applied bit rate in at least one transmission band and monitoring of error counters.

It must be noted that in the sense of the invention, training means an actual interruption of the data transmission in the case of which the corresponding test data transmission determines the maximum possible data transmission rate. In this case, a pseudo-random number pattern is given as an analog signal on the line and transmitted to the receiver. The receiver, based on the changes of this random number sequence known to him can decide on the properties of the line and set his equalization coefficients in such a way that the line distortions are compensated for in the best possible way.

According to the invention, this basic idea can, on the on hand, be implemented by means of the fact that the data transmission rate of only one frequency band to be transmitted as useful data is increased, that is optimized or, on the other hand, by means of the fact that in order to determine the highest possible data transmission rate, one frequency band is used via which no useful data is transmitted during this procedure.

According to the invention, it is also proposed that the approximation to a higher data transmission rate is undertaken step-by-step and subsequently oscillates around the optimum data transmission rate depending on the data transmission quality having been achieved.

In addition to the above-mentioned method, the inventor also proposes a device for optimized ADSL data transmission, preferably according to the Standard T1.413 or ITU G992.1, whereby means, preferably program means or program modules, are provided that carry out one of the methods described previously.

### BRIEF DESCRIPTION OF THE DRAWINGS

The invention is explained in greater detail below on the basis of the preferred embodiments and the accompanying drawings. They are as follows:

FIG. 1: Diagram of an ADSL connection;

FIG. 2a: Short-term fault in an ADSL connection during the training period;

FIG. 2b: Medium-term fault in an ADSL connection during the training period;

FIG. 2c: Long-term fault in an ADSL connection during the training period;

FIG. 3: Fault adaptation method for self-correction of the actual bit rate;

FIG. 4: ADSL frequency band characteristics with identification of an individual bin for optimized transmission;

FIG. 5: ADSL assemblies with modules for the method according to the invention.

### DETAILED DESCRIPTION OF INVENTION

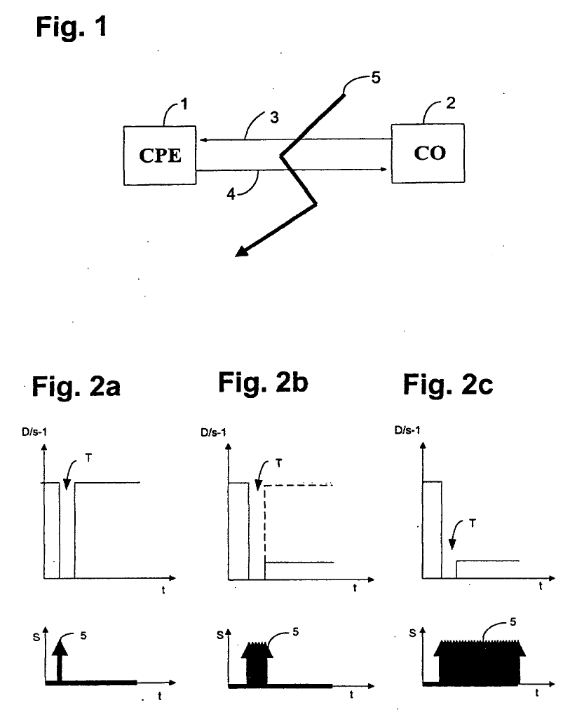

FIG. 1 is a diagram of an ADSL connection between an end customer 1 and a local switching center 2 with the two directed data flows 3 and 4 (data downstream and data upstream) with the action of a fault restricted in time shown by the arrow 5.

Such a fault 5 is shown in a time diagram in FIGS. 2a to 2c. The coordinate axes arranged in the top part of the figures in each case show the data rate D over time t. At the same time, fault S is plotted over time t.

FIG. 2a shows a very short-term fault 5 that initiates a training phase T shown in the diagram below it where the data rate momentarily falls to 0 because no useful data is transmitted during the training.

Following the training phase, in the situation of FIG. 2a the full technically possible data rate is again determined as the highest possible data transmission rate and with this the data transmission continues.

FIG. 2c shows a situation, whereby a long-duration fault 5 occurs that in its time curve persists considerably longer than the training phase T so that following the training phase it is actually only possible to continue with a lower data transmission rate based on the line faults so that this lower data transmission rate is retained after the training phase T.

Finally, in FIG. 2b the basic situation according to the invention is shown, whereby the faults 5 persist for a period that more or less corresponds to the training phase so that during the training, based on the faults occurring there, a lower possible data transmission rate is determined and subsequently the data is also transmitted at this lower rate. However, unfavorable here is the fact that the duration of the fault only corresponded to the duration of the training phase so that subsequently an actual higher data rate would be possible, but the connection to the lower data rate is still functional. Because no further faults occur, a new training phase is also not initiated so that an unfavorable transmission rate is manifested although it would actually be possible to carry out a higher data transmission rate as is shown with the dotted lines.

According to the invention, despite training carried out previously, during a data transfer period following a training phase an attempt is continuously made to increase the data transmission rate even during the transmission of data without further faults in which case at the same time by using auxiliary means such as error counts, for example, the HEC error, the CRC error or the SES count that are nevertheless available in the above-mentioned standards, it is evaluated whether or not the increase in the data transmission rate yields weaker results. When improving the result, the data transmission rate is increased further and when the result becomes weaker, the data transmission rate is reduced to a small degree.

In principle, two different possibilities are available for this in the ADSL method. On the one hand, the data transmission rate can be increased on one or all the useful channels or a specific frequency band can be selected that is used to test the increased data rate in which case the result is subsequently transferred to the other frequency bands via which useful data is transmitted.

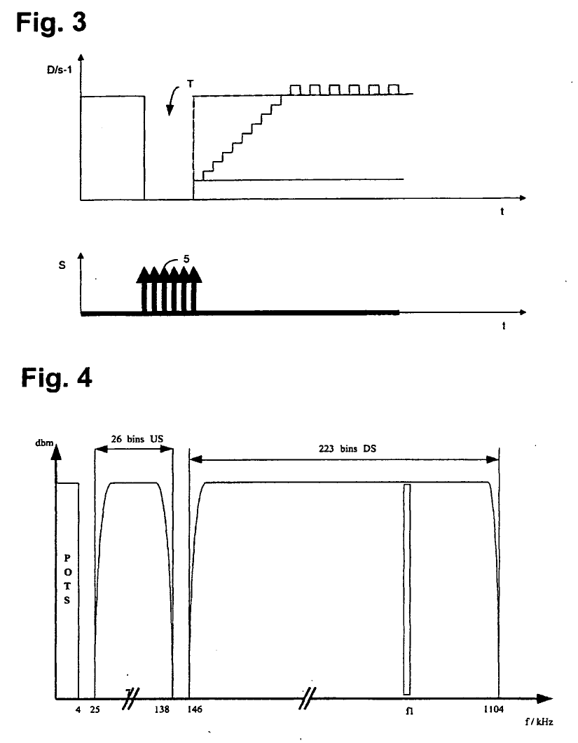

FIG. 3 shows the situation of the method mentioned first. Here, according to FIGS. 2a to 2c, the data transmission rate D compared with the time is plotted in the top part of the coordinate system of the figure. Following a normal data transmission there is a fault S that initiates a training phase T and persists slightly longer than the duration of the training phase. Because the fault signal subsequently does not arrive, it would theoretically and technically be possible to carry out the dotted data transmission rate, but on the basis of the training a lower possible data transmission rate was determined during the fault and the data transmission rate with this lower rate was used as a starting basis. According to the invention, the successive increase in the data rate during the transmission of useful data leads to the fact that a cautious approach of the actually applied data transmission rate to the technically possible data transmission rate follows and after the approach to the technically possible data rate “oscillates” in the range of the technically highest possible data transmission rate.

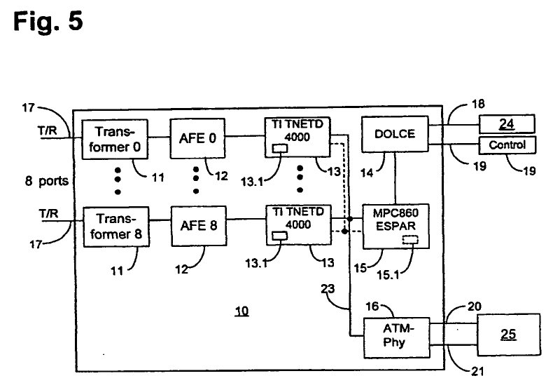

FIG. 4 shows the second variant of continuously testing the highest possible data transmission rate. This shows the frequency bands of an ADSL connection in which case at the start the frequencies of the POTS (=plain old telephone service), 26 bins for the upstream channel (bins 6-31) and subsequently the 223 bins for the downstream channel (bins 33-255) are shown. A frequency f1 is highlighted in the frequency band of the downstream channels. This was selected arbitrarily in each case in order to carry out the cautious approach of the data transmission rate to the maximum possible rate via this frequency band in which case useful data is not transmitted via this frequency band. If a required increase or decrease in the data transmission rate is determined in this frequency band, the other frequencies of the ADSL method will also use this procedure.

Therefore, the method according to the invention prevents that a fault that is only shown in the training phase, manifests a data transmission rate in an ADSL connection that is essentially too low.

According to the idea of the invention, the inventor also proposes a device for optimized data transmission in an ADSL method. Such a device is shown in FIG. 5 as an assembly (line card) 10 that can be fitted in a local switching center. This assembly 10 has 8 ports (inputs/outputs) 17 for connecting to 8 subscriber lines. Behind the 8 ports 17 there is a transformer in each case (transformer 0 to transformer 8) 11 each with an analog/digital converter and amplifier level (AFE 0 to AFE 8, AFE=Analog Front End) 12 that carries out the conversion between the analog line signals and the digital data sequences.

Subsequently, each line has a Texas instrument TNETD4000 chip set 13 in which the ADSL standard is implemented according to T1.413 or G992.1. Here, according to the idea of the invention the method according to the invention can be installed by adapting the software and/or adding corresponding software modules 13.1.

Another development of the invention can be based on the fact that the method according to the invention is implemented below in the data controller (MPC860ESAR) 15 shown here by mean of dotted lines in function 15.1 so that the method according to the invention can run independently of and separately from the standard ADSL method.

Via the chip ATM-Phy 16 that is connected to the ATM network of the line card by means of UTOPIA 22 (universal test & operations physical interface for ATM) bus, the data is connected to the digital ATM telecommunications network with two redundantly embodied lines 20 and 21 according to ATM25, whereas the voice parts are routed to the analog telecommunication network 24 via the chip DOLCE (dedicated one chip line card controller extended) 14. This analog network on line 18 functions with pulse code modulated (PCM) voice data that is generated in the DOLCE processor 14. The DOLCE chip can be actuated from a higher level of the analog telecommunications network by a control interface 23 (CONTROL) via line 19.

It goes without saying that the above-mentioned features of the invention can be used in both the given combination and in other combinations or stand-alone, without moving beyond the framework of this invention.

1-8. (canceled)

9. A method for optimized ADSL data transmission, comprising:
initiating a training procedure upon an occurrence of a line fault to determine the highest possible data transmission rate, wherein
during an uninterrupted data transfer period following a training phase, a highest possible data transmission rate is also set without carrying out a new training, by successive increases in the applied bit rate in at least one transmission band and monitoring of error counts.

10. A method according to claim 9, wherein to determine the highest possible data transmission rate, the data transmission rate of only one frequency band to be transmitted as useful data is increased.

11. A method according to claim 9, wherein to determine the highest possible data frequency rate, one frequency band is used via which no useful data is transmitted during this procedure.

12. A method according to claim 9, wherein the approach to a higher data transmission rate takes place stepwise and subsequently oscillates around the optimum data transmission rate after the data transmission quality has been reached.

13. A method according to claim 10, wherein the approach to a higher data transmission rate takes place stepwise and subsequently oscillates around the optimum data transmission rate after the data transmission quality has been reached.

14. A method according to claim 11, wherein the approach to a higher data transmission rate takes place stepwise and subsequently oscillates around the optimum data transmission rate after the data transmission quality has been reached.

15. A method according to claim 9, wherein the HEC error of the ADSL method according to T1.413 or ITU G992.1 is used as the error count.

16. A method according to claim 10, wherein the HEC error of the ADSL method according to T1.413 or ITU G992.1 is used as the error count.

17. A method according to claim 9, wherein the CRC error of the ADSL method according to T1.413 or ITU G992.1 is used as the error count.

18. A method according to claim 10, wherein the CRC error of the ADSL method according to T1.413 or ITU G992.1 is used as the error count.

19. A method according to claim 9, wherein the SES count of the ADSL method according to T1.413 or ITU G992.1 is used as the error count.

20. A method according to claim 10, wherein the SES count of the ADSL method according to T1.413 or ITU G992.1 is used as the error count.

21. A method according to claim 9, wherein the ADSL data transmission is according to the standard T1.413 or ITU G992.1.

22. An apparatus for optimized ADSL data transmission having a mechanism for performing a method, the method comprising:
initiating a training procedure upon an occurrence of a line fault to determine the highest possible data transmission rate, wherein
during an uninterrupted data transfer period following a training phase, a highest possible data transmission rate is also set without carrying out a new training, by successive increases in the applied bit rate in at least one transmission band and monitoring of error counts.

23. An apparatus according to claim 22, wherein the mechanism comprises program means or program modules.
